(19) United States
(12) Patent Application Publication
(10) Pub. No.: US 2025/0063444 A1
(43) Pub. Date: Feb. 20, 2025

(54) FRAMEWORK AND MECHANISM TO SUPPORT SKIPPING CELL DETECTION AND SIB READING

(71) Applicant: QUALCOMM Incorporated, San Diego, CA (US)

(72) Inventors: Jiaheng LIU, Shanghai (CN); Peng HU, Beijing (CN); Kainan LI, Beijing (CN); Vihanga Mahendra BARE, San Jose, CA (US); Tom CHIN, San Diego, CA (US); Subashini KRISHNAMURTHY, San Diego, CA (US); Xiaoning LU, San Diego, CA (US)

(21) Appl. No.: 18/720,543

(22) PCT Filed: Mar. 4, 2022
(86) PCT No.: PCT/CN2022/079176

§ 371 Date: Jun. 14, 2024

(51) Int. Cl. H04W 36/00; H04W 36/08; H04W 36/30

(52) U.S. Cl. CPC H04W 36/0085; H04W 36/0061; H04W 36/08; H04W 36/304

(57) ABSTRACT

A UE may obtain one or more measurements of at least one cell of a network based on a first connection with the network. The UE may reuse at least a first measurement of the one or more measurements for a second connection with the network. The first connection with the network and the second connection with the network may be associated with different subscriptions or different RATs. To reuse at least the first measurement of the one or more measurements for the second connection with the network, the UE may skip a cell detection operation associated with the second connection with the network.

### TECHNICAL FIELD

The present disclosure relates generally to communication systems, and more particularly, to skipping cell detection and/or system information block (SIB) reading in a wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may obtain one or more measurements of at least one cell of a network based on a first connection with the network. The apparatus may reuse at least a first measurement of the one or more measurements for a second connection with the network. The first connection with the network and the second connection with the network may be associated with different subscriptions or different radio access technologies (RATs).

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating a flow diagram associated with an example framework usable by a UE for skipping cell detection and/or SIB reading according to one aspect.

FIG. 5 is a diagram illustrating an example flow diagram for skipping cell detection according to one aspect.

FIG. 6 is a diagram of a communication flow of a method of wireless communication.

FIG. 7 is a flowchart of a method of wireless communication.

FIG. 8 is a flowchart of a method of wireless communication.

FIG. 9 is a diagram illustrating an example of a hardware implementation for an example apparatus and/or network entity.

### DETAILED DESCRIPTION

Before a UE may camp on a cell, the UE may first detect the cell (i.e., cell detection), and then may read one or more SIBs (e.g., receive and decode one or more SIBs). Cell detection and SIB reading may take a certain period of time. The period of time associated with cell detection and/or SIB reading may cause data transmission holes/interruptions (e.g., periods where data transmission may not take place) and/or redirection delays (e.g., the LTE-to-NR (L2NR) redirection delay). Accordingly, it may be desirable to reduce or eliminate the period of time or delay associated with cell detection and/or SIB reading. One or more aspects of the disclosure may relate to a common framework usable by a UE to camp on a cell directly and skip cell detection and/or SIB reading. Therefore, interruption to data transmission may be reduced and minimized in these scenarios.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

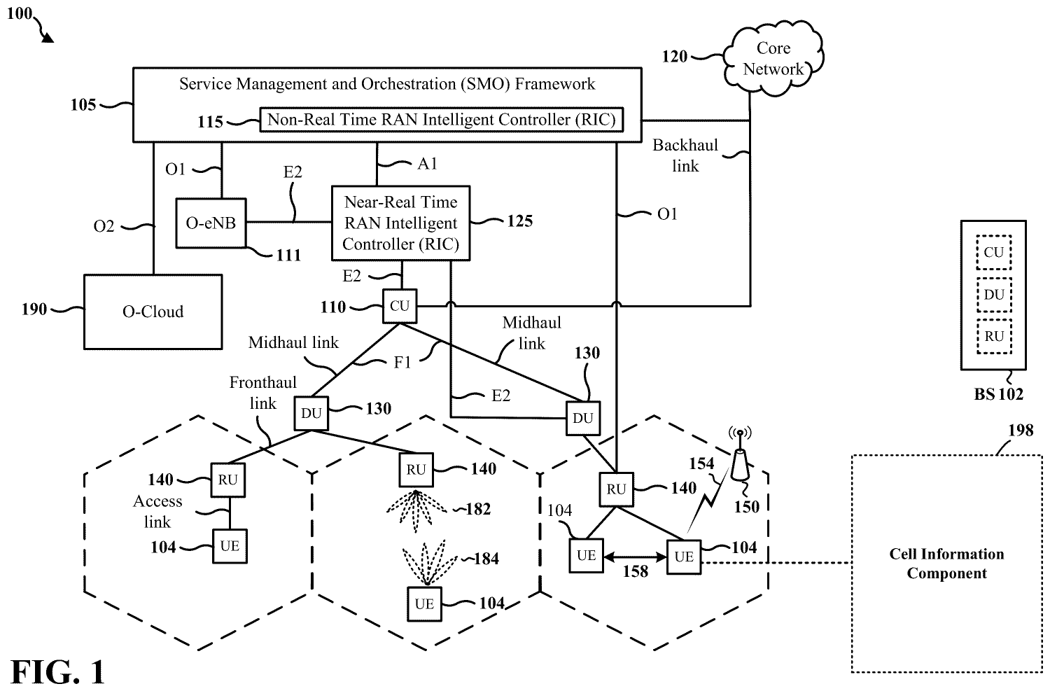

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a cell information component 198 that may be configured to obtain one or more measurements of at least one cell of a network based on a first connection with the network. The cell information component 198 may be configured to reuse at least a first measurement of the one or more measurements for a second connection with the network. The first connection with the network and the second connection with the network may be associated with different subscriptions or different RATs. Although the following description may be focused on 5G NR, the concepts described herein may be applicable to other similar areas, such as LTE, LTE-A, CDMA, GSM, and other wireless technologies.

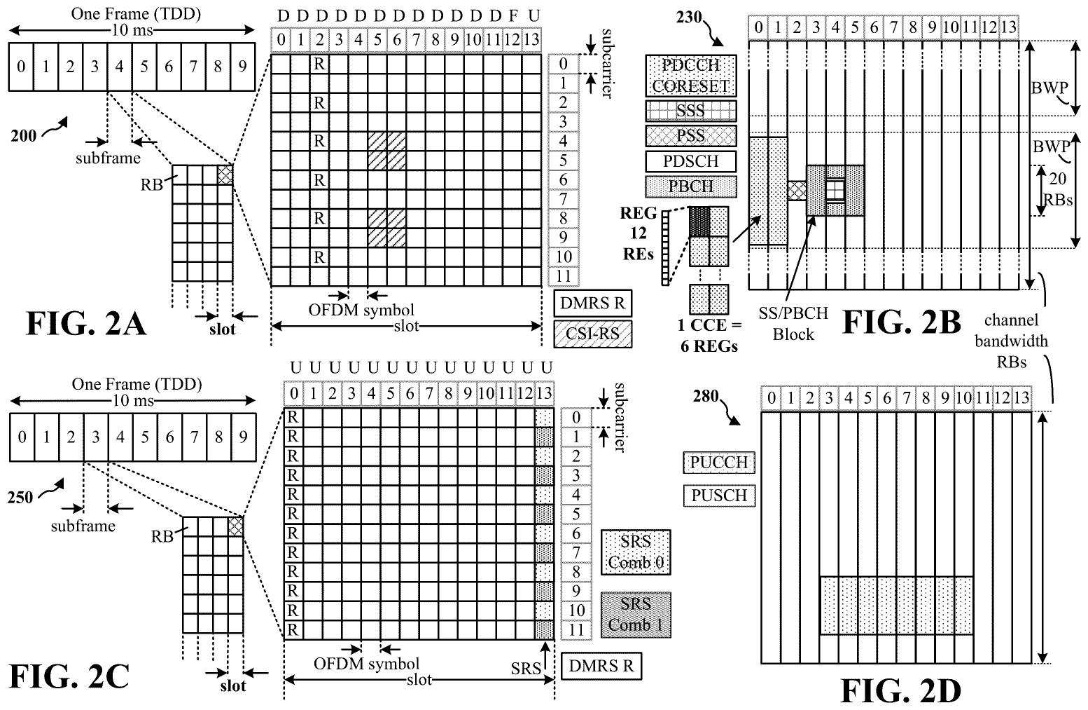

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

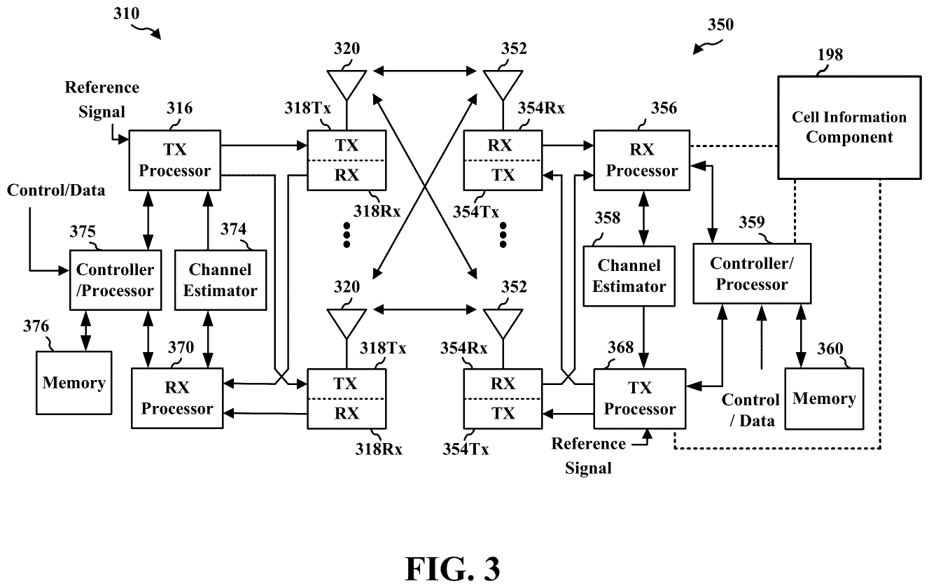

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the cell information component 198 of FIG. 1.

A multi-subscriber identity module (SIM) (MSIM) capable UE may camp on a cell for each of the subscriptions (e.g., each SIM may be associated with a subscription). Further, a UE (e.g., a regular single SIM (SSIM) UE) may camp on a cell in such scenarios as inter-RAT (IRAT) redirection (e.g., LTE to NR (L2NR) redirection), an intra-RAT cell reselection (e.g., an NR2NR reselection), a recover from an out of service (OOS) state, or a recovery from a radio link failure (RLF), etc. Herein the RATs may include the LTE, the NR, or any other suitable RAT.

Before a UE may camp on a cell, the UE may first detect the cell (i.e., cell detection), and then may read one or more SIBs (e.g., receive and decode one or more SIBs). Cell detection and SIB reading may take a certain period of time. For example, cell detection may take more than 60 ms, and it may take approximately 100 ms to read SIBs. The period of time associated with cell detection and/or SIB reading may cause data transmission holes/interruptions (e.g., periods where data transmission may not take place) and/or redirection delays (e.g., the L2NR redirection delay). Accordingly, it may be desirable to reduce or eliminate the period of time or delay associated with cell detection and/or SIB reading.

One or more aspects of the disclosure may relate to a common framework usable by a UE to camp on a cell directly and skip cell detection and/or SIB reading. In one or more configurations, an MSIM UE may use the framework in scenarios such as IRAT reselection (e.g., L2NR reselection), cell reselection (e.g., NR2NR reselection), non-access stratum (NAS) service request, subscription power-on, OOS recovery, or RLF recovery, etc. In some configurations, the MSIM UE may use the framework when the different subscriptions are associated with connections to a same network (e.g., when the SIMs belong to a same operator, or when the subscriptions are associated with roaming in a same network, etc.). In one or more configurations, a regular UE (e.g., an SSIM UE) may use the framework in such scenarios as IRAT reselection (e.g., L2NR reselection), etc.

In one or more configurations, the common framework may include a common buffer for cell information storage. Further, the common framework may include a unified call flow for skipping cell detection and/or SIB reading.

In one or more configurations, in an MSIM UE, to perform an IRAT reselection (e.g., L2NR reselection) or a cell reselection (e.g., NR2NR reselection) for a second subscription, if the reselection target cell is a neighbor cell in a first subscription and the cell quality (e.g., a reference signal received power (RSRP) or signal-to-noise ratio (SNR)) as measured using the connection for the first subscription is greater than a threshold, the MSIM UE may apply the framework, may skip cell detection, and may reuse the cell measurement results from the first subscription for the second subscription.

In one or more configurations, in an MSIM UE, to perform an IRAT reselection (e.g., L2NR reselection) or a cell reselection (e.g., NR2NR reselection) for a second subscription, if the reselection target cell is a serving cell in a first subscription and the cell quality as measured using the connection for the first subscription is greater than a threshold, the MSIM UE may apply the framework, may skip cell detection and SIB reading, and may reuse the cell measurement results and the system information from the SIBs from the first subscription for the second subscription.

In one or more configurations, in an MSIM UE, to recover from OOS or RLF for a second subscription, if the cell quality of the serving cell of a first subscription as measured using the connection for the first subscription is greater than a threshold, the MSIM UE may apply the framework, may skip cell detection and SIB reading, and may camp on the same cell (i.e., the serving cell of the first subscription) for the second subscription to recover the second subscription from OOS or RLF.

In one or more configurations, in a regular UE (e.g., an SSIM UE), to perform an IRAT reselection (e.g., L2NR reselection) from a first RAT to a second RAT, the UE may rely on and reuse, for the second RAT, the measurement result obtained using the connection for the first RAT, may apply the framework, and may skip cell detection.

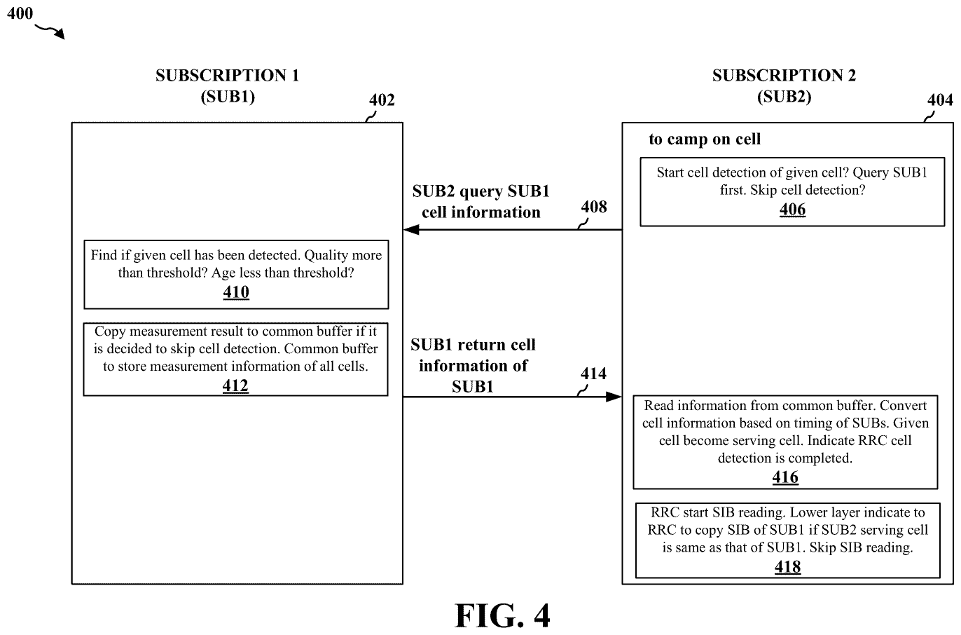

FIG. 4 is a diagram illustrating a flow diagram associated with an example framework 400 usable by a UE for skipping cell detection and/or SIB reading according to one aspect. The example framework 400 may be usable by the UE 104/350. At 406, to camp on a target cell for a second subscription 404, the UE may determine whether to perform or skip cell detection. To make the determination, the UE (operating for the second subscription 404) may query the first subscription 402. Accordingly, at 408, the UE (operating for the second subscription 404) may query the cell information from the first subscription 402. At 410, the UE (operating for the first subscription 402) may identify whether the target cell of the second subscription 404 (the given cell) has been detected. In one or more configurations, if the given cell has been detected in the first subscription 402, the UE (operating for the first subscription 402) may further identify whether the cell quality (e.g., the RSRP and/or the SNR) is greater than a threshold. Further, the UE (operating for the first subscription 402) may identify whether the age of the measurement results (e.g., the time duration from the time of measurement to the time of determination) for the given cell is less than a threshold. In one or more configurations, the UE may decide to skip cell detection for the second subscription 404 if the cell quality of the given cell is greater than the corresponding threshold and/or the age of the measurement results for the given cell is less than the corresponding threshold.

At 412, the UE (operating for the first subscription 402) may copy the measurement results (e.g., RSRP, SNR, reference signal received quality (RSRQ), cell timing, automatic gain control (AGC) information, automated frequency coordination (AFC) information, or SSB information, etc.) of at least the given cell to a common buffer if the UE decides to skip cell detection for the second subscription 404. In one or more configurations, the UE (operating for the first subscription 402) may copy the measurement results of all cells corresponding to a frequency (e.g., one frequency may be associated with multiple cells) to the common buffer. At 414, the UE (operating for the first subscription 402) may return the cell information of the first subscription 402 to the second subscription 404 (e.g., via the common buffer). At 416, the UE (operating for the second subscription 404) may read the cell information from the common buffer. Further, the UE (operating for the second subscription 404) may convert the cell information from the first subscription 402 for use by the second subscription 404 based on the timing of the first subscription 402 and the second subscription 404 (e.g., the first subscription 402 and the second subscription 404 may have different timing sources; converting the cell information from the first subscription 402 for use by the second subscription 404 may be based on timing values from both timing sources). Accordingly, the given (target) cell may become the serving cell for the second subscription 404. The UE (operating for the second subscription 404) may indicate that the RRC cell detection is completed without performing actual cell detection for the second subscription 404.

At 418, the UE (at the RRC layer) may start SIB reading upon the RRC layer receiving the cell detection result. If the serving cell of the second subscription 404 is the same cell as the serving cell of the first subscription 402, a lower layer (e.g., a PHY layer and/or a MAC layer) may indicate a SIB decoding success result to the RRC layer, and the UE (at the RRC layer) may copy the information of one or more SIBs of the first subscription 402 for use by the second subscription 404. Accordingly, SIB reading for the second subscription 404 may be skipped.

Accordingly, in one or more configurations, in an MSIM UE, to perform an IRAT reselection (e.g., L2NR reselection) or a cell reselection (e.g., NR2NR reselection) for a second subscription, if the reselection target cell (which may be inputted into the framework 400) is a serving cell in a first subscription, the MSIM UE may apply the framework, may skip cell detection and SIB reading, and may reuse the cell measurement results and the system information contained in SIBs from the first subscription. In one or more configurations, the cell detection and SIB reading may be skipped if the cell quality as measured using the connection for the first subscription is greater than a threshold.

In one or more configurations, in an MSIM UE, to perform an IRAT reselection (e.g., L2NR reselection) or a cell reselection (e.g., NR2NR reselection) for a second subscription, if the reselection target cell (which may be inputted into the framework 400) is a neighbor cell in a first subscription, the MSIM UE may apply the framework, may skip cell detection, and may reuse the cell measurement results from the first subscription for the second subscription. In one or more configurations, the cell detection may be skipped if the cell quality as measured using the connection for the first subscription is greater than a threshold. In one or more configurations, if the conditions for skipping cell detections and/or SIB reading are not met, to perform the reselection for the second subscription, the MSIM UE may follow existing procedures, and may start cell detection followed by SIB reading.

In one or more configurations, in an MSIM UE, to recover from OOS or RLF for a second subscription, if the cell quality of the serving cell of a first subscription as measured using the connection for the first subscription is greater than a threshold, the MSIM UE may apply the framework, may skip cell detection and SIB reading, and may directly camp on the same cell (i.e., the serving cell of the first subscription) for the second subscription to recover the second subscription from OOS or RLF.

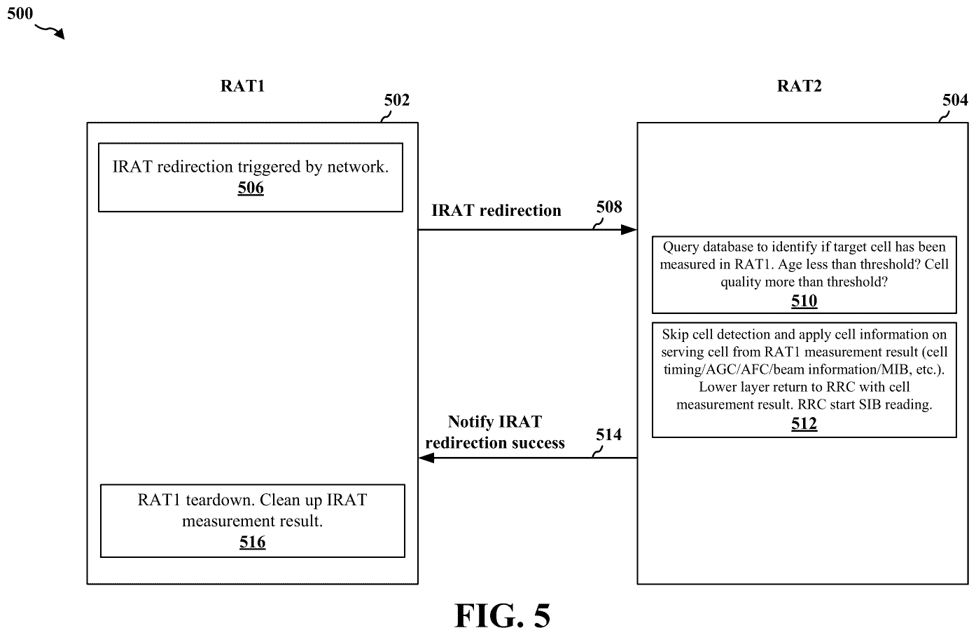

FIG. 5 is a diagram illustrating an example flow diagram 500 for skipping cell detection according to one aspect. The process of the flow diagram 500 may be performed by a regular UE (e.g., an SSIM UE) (e.g., UE 104/350) for IRAT redirection. The first RAT 502 or the second RAT 504 may be LTE, NR, or any other suitable RAT. In one example, the first RAT 502 may be LTE, and the second RAT 504 may be NR. In another example, the first RAT 502 may be NR, and the second RAT 504 may be LTE. In yet additional examples, the first RAT 502 and the second RAT 504 may be suitable different RATs. At 506, the network to which the UE is connected may trigger an IRAT redirection from the first RAT 502 to the second RAT 504 (e.g., blindly or based on a measurement result). At 508, the UE (operating for the first RAT 502) may initiate the IRAT redirection to the second RAT 504. At 510, the UE (operating for the second RAT 504) may query an internal database/buffer to identify whether the target cell of the IRAT redirection has been measured using the connection in association with the first RAT 502. If the target cell of the IRAT redirection has been measured using the connection in association with the first RAT 502, in one or more configurations, the UE (operating for the second RAT 504) may identify whether the age of the measurement results of the target cell as measured using the connection in association with the first RAT 502 is less than a threshold. In one or more further configurations, the UE (operating for the second RAT 504) may identify whether the cell quality of the target cell as measured using the connection in association with the first RAT 502 is greater than a threshold. In one or more configurations, cell detection for the IRAT redirection to the second RAT 504 may be skipped if the age of the measurement results of the target cell as measured using the connection in association with the first RAT 502 is less than the corresponding threshold and/or the cell quality of the target cell as measured using the connection in association with the first RAT 502 is greater than the corresponding threshold.

At 512, the UE (operating for the second RAT 504) may skip cell detection, and may reuse and apply the cell information of the serving cell from the measurement results of the serving cell as measured using the connection in association with the first RAT 502. The cell information may include cell timing, AGC information, AFC information, beam information, information from the MIB, etc. In particular, a lower layer (e.g., a PHY layer and/or a MAC layer) may return the cell measurement results to the RRC layer. Further, the UE (operating for the second RAT 504) (at the RRC layer) may start SIB reading (e.g., SIB receiving and decoding). Skipping cell detection and reusing the measurement results may reduce interruption (e.g., by approximately 100 ms) to the transmission of packet-switched data during the IRAT transition. At 514, the UE (operating for the second RAT 504) may notify the first RAT 502 of the IRAT redirection success. At 516, the UE (operating for the first RAT 502) may tear down the connection in association with the first RAT 502. Further, in some examples, the UE (operating for the first RAT 502) may clean up the IRAT measurement results.

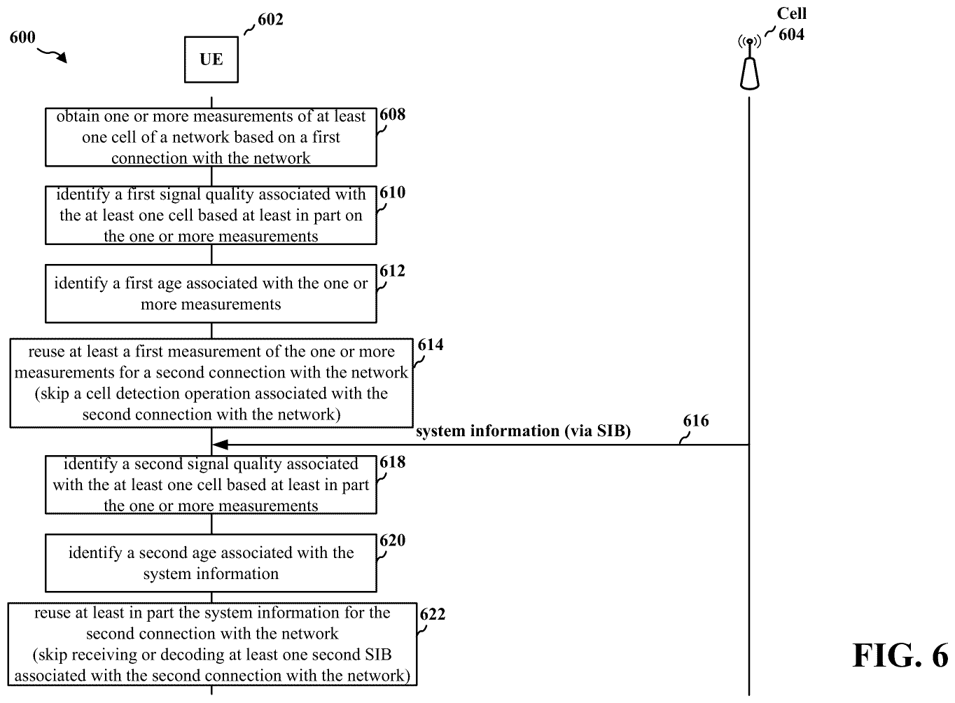

FIG. 6 is diagram of a communication flow 600 of a method of wireless communication. At 608, the UE 602 may obtain one or more measurements of at least one cell 604 of a network based on a first connection with the network.

At 610, the UE 602 may identify a first signal quality associated with the at least one cell 604 based at least in part on the one or more measurements. At least a first measurement of the one or more measurements may be reused for a second connection if the first signal quality is greater than a first threshold. In one configuration, the first signal quality may correspond to an SNR or an RSRP.

At 612, the UE 602 may identify a first age associated with the one or more measurements. At least the first measurement of the one or more measurements may be reused for the second connection if the first age is less than a second threshold.

At 614, the UE 602 may reuse at least the first measurement of the one or more measurements for the second connection with the network. In other words, the UE 602 may skip a cell detection operation associated with the second connection with the network. The first connection with the network and the second connection with the network may be associated with different subscriptions or different RATs.

In one configuration, the first connection with the network may be associated with a first subscription. The second connection with the network may be associated with a second subscription. The at least one cell 604 of the network may correspond to a neighbor cell for the first connection. The at least one cell 604 of the network may correspond to a serving cell for the second connection. In one configuration, the second connection with the network may be associated with a cell reselection.

In one configuration, the first connection with the network may be associated with a first RAT. The second connection with the network may be associated with a second RAT. The second connection with the network may be associated with an IRAT redirection.

At 616, the UE 602 may obtain system information of the at least one cell 604 of the network from at least one first SIB based on the first connection with the network.

At 618, the UE 602 may identify a second signal quality associated with the at least one cell 604 based at least in part on the one or more measurements. The system information 616 may be reused at least in part for the second connection if the second signal quality is greater than a third threshold. In one configuration, the second signal quality may correspond to an SNR or an RSRP.

At 620, the UE 602 may identify a second age associated with the system information 616. The system information may be reused at least in part for the second connection if the second age is less than a fourth threshold.

At 622, the UE 602 may reuse at least in part the system information 616 for the second connection with the network. In other words, the UE 602 may skip receiving or decoding at least one second SIB associated with the second connection with the network.

In one configuration, the first connection with the network may be associated with a first subscription. The second connection with the network may be associated with a second subscription. The at least one cell 604 of the network may correspond to a serving cell for the first connection. The at least one cell 604 of the network may correspond to a serving cell for the second connection. In one configuration, the second connection with the network may be associated with a cell reselection.

In one configuration, the second connection with the network may be associated with a recovery from an OOS or an RLF.

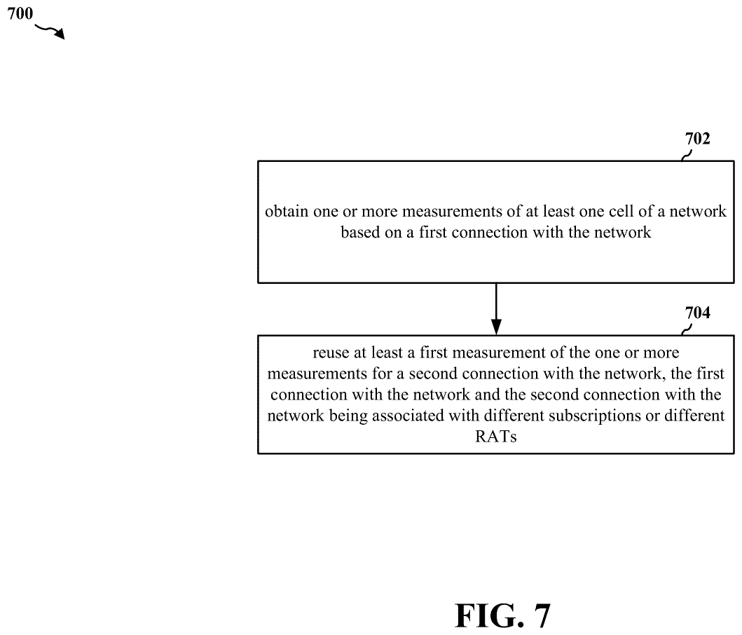

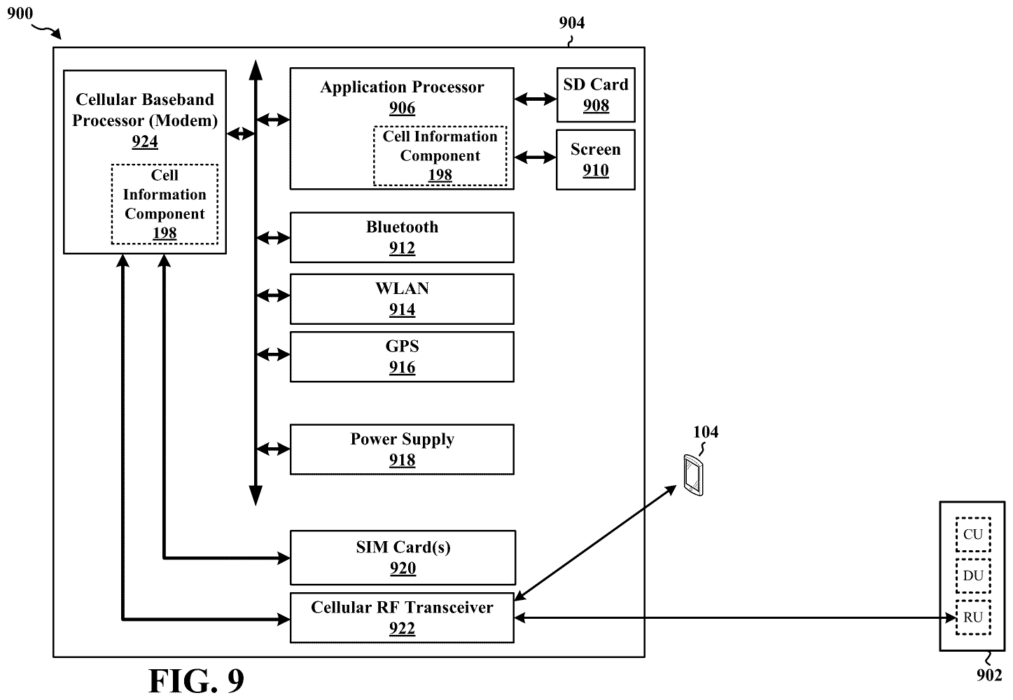

FIG. 7 is a flowchart 700 of a method of wireless communication. The method may be performed by a UE (e.g., the UE 104/350/602; the apparatus 904). At 702, the UE may obtain one or more measurements of at least one cell of a network based on a first connection with the network. For example, 702 may be performed by the cell information component 198 in FIG. 9. Referring to FIG. 6, at 608, the UE 602 may obtain one or more measurements of at least one cell 604 of a network based on a first connection with the network.

At 704, the UE may reuse at least a first measurement of the one or more measurements for a second connection with the network. The first connection with the network and the second connection with the network may be associated with different subscriptions or different RATs. For example, 704 may be performed by the cell information component 198 in FIG. 9. Referring to FIG. 6, at 614, the UE 602 may reuse at least a first measurement of the one or more measurements for a second connection with the network.

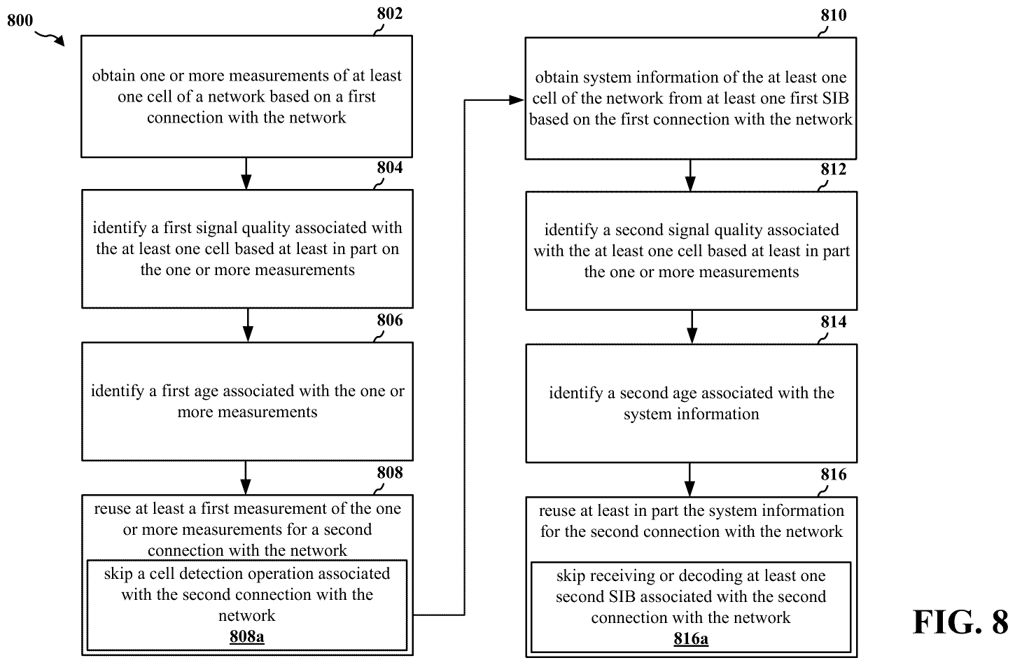

FIG. 8 is a flowchart 800 of a method of wireless communication. The method may be performed by a UE (e.g., the UE 104/350/602; the apparatus 904). At 802, the UE may obtain one or more measurements of at least one cell of a network based on a first connection with the network. For example, 802 may be performed by the cell information component 198 in FIG. 9. Referring to FIG. 6, at 608, the UE 602 may obtain one or more measurements of at least one cell 604 of a network based on a first connection with the network.

At 808, the UE may reuse at least a first measurement of the one or more measurements for a second connection with the network. The first connection with the network and the second connection with the network may be associated with different subscriptions or different RATs. For example, 808 may be performed by the cell information component 198 in FIG. 9. Referring to FIG. 6, at 614, the UE 602 may reuse at least a first measurement of the one or more measurements for a second connection with the network.

In one configuration, at 804, the UE may identify a first signal quality associated with the at least one cell based at least in part on the one or more measurements. At least the first measurement of the one or more measurements may be reused for the second connection if the first signal quality is greater than a first threshold. For example, 804 may be performed by the cell information component 198 in FIG. 9. Referring to FIG. 6, at 610, the UE 602 may identify a first signal quality associated with the at least one cell 604 based at least in part on the one or more measurements.

In one configuration, the first signal quality may correspond to an SNR or an RSRP.

In one configuration, at 806, the UE may identify a first age associated with the one or more measurements. At least the first measurement of the one or more measurements may be reused for the second connection if the first age is less than a second threshold. For example, 806 may be performed by the cell information component 198 in FIG. 9. Referring to FIG. 6, at 612, the UE 602 may identify a first age associated with the one or more measurements.

In one configuration, to reuse at least the first measurement of the one or more measurements for the second connection with the network, at 808a, the UE may skip a cell detection operation associated with the second connection with the network. For example, 808a may be performed by the cell information component 198 in FIG. 9. Referring to FIG. 6, at 614, the UE 602 may skip a cell detection operation associated with the second connection with the network.

In one configuration, the first connection with the network may be associated with a first subscription. The second connection with the network may be associated with a second subscription. The at least one cell of the network may correspond to a neighbor cell for the first connection. The at least one cell of the network may correspond to a serving cell for the second connection.

In one configuration, the second connection with the network may be associated with a cell reselection.

In one configuration, the first connection with the network may be associated with a first RAT. The second connection with the network may be associated with a second RAT. The second connection with the network may be associated with an IRAT redirection.

In one configuration, at 810, the UE may obtain system information of the at least one cell of the network from at least one first SIB based on the first connection with the network. For example, 810 may be performed by the cell information component 198 in FIG. 9. Referring to FIG. 6, at 616, the UE 602 may obtain system information of the at least one cell 604 of the network from at least one first SIB based on the first connection with the network.

At 816, the UE may reuse at least in part the system information for the second connection with the network. For example, 816 may be performed by the cell information component 198 in FIG. 9. Referring to FIG. 6, at 622, the UE 602 may reuse at least in part the system information 616 for the second connection with the network.

In one configuration, at 812, the UE may identify a second signal quality associated with the at least one cell based at least in part on the one or more measurements. The system information may be reused at least in part for the second connection if the second signal quality is greater than a third threshold. For example, 812 may be performed by the cell information component 198 in FIG. 9. Referring to FIG. 6, at 618, the UE 602 may identify a second signal quality associated with the at least one cell 604 based at least in part on the one or more measurements.

In one configuration, at 814, the UE may identify a second age associated with the system information. The system information may be reused at least in part for the second connection if the second age is less than a fourth threshold. For example, 814 may be performed by the cell information component 198 in FIG. 9. Referring to FIG. 6, at 620, the UE 602 may identify a second age associated with the system information 616.

In one configuration, to reuse at least in part the system information for the second connection with the network, at 816a, the UE may skip receiving or decoding at least one second SIB associated with the second connection with the network. For example, 816a may be performed by the cell information component 198 in FIG. 9. Referring to FIG. 6, at 622, the UE 602 may skip receiving or decoding at least one second SIB associated with the second connection with the network.

In one configuration, the first connection with the network may be associated with a first subscription. The second connection with the network may be associated with a second subscription. The at least one cell of the network may correspond to a serving cell for the first connection. The at least one cell of the network may correspond to a serving cell for the second connection.

In one configuration, the second connection with the network may be associated with a cell reselection.

In one configuration, the second connection with the network may be associated with a recovery from an OOS or an RLF.

FIG. 9 is a diagram 900 illustrating an example of a hardware implementation for an apparatus 904 and a network entity 902. The apparatus 904 may be a UE, a component of a UE, or may implement UE functionality. The network entity 902 may be a BS, a component of a BS, or may implement BS functionality. In some aspects, the apparatus 904 may include a cellular baseband processor 924 (also referred to as a modem) coupled to a cellular RF transceiver 922. In some aspects, the apparatus 904 may further include one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, or a power supply 918. The cellular baseband processor 924 communicates through the cellular RF transceiver 922 with the UE 104 and/or with an RU associated with the network entity 902. The RU is either part of the network entity 902 or is in communication with the network entity 902. The network entity 902 may include one or more of the CU, DU, and the RU. The cellular baseband processor 924 and the application processor 906 may each include a computer-readable medium/memory. Each computer-readable medium/memory may be non-transitory. The cellular baseband processor 924 and the application processor 906 are each responsible for general processing, including the execution of software stored on the computer-readable medium/memory. The software, when executed by the cellular baseband processor 924/application processor 906, causes the cellular baseband processor 924/application processor 906 to perform the various functions described supra. The computer-readable medium/memory may also be used for storing data that is manipulated by the cellular baseband processor 924/application processor 906 when executing software. The cellular baseband processor 924/application processor 906 may be a component of the UE 350 and may include the memory 360 and/or at least one of the TX processor 368, the RX processor 356, and the controller/processor 359. In one configuration, the apparatus 904 may be a processor chip (modem and/or application) and include just the cellular baseband processor 924 and/or the application processor 906, and in another configuration, the apparatus 904 may be the entire UE (e.g., see 350 of FIG. 3) and include the additional modules of the apparatus 904.

As discussed supra, the component 198 may be configured to obtain one or more measurements of at least one cell of a network based on a first connection with the network. The component 198 may reuse at least a first measurement of the one or more measurements for a second connection with the network. The first connection with the network and the second connection with the network may be associated with different subscriptions or different RATs. The component 198 may be within the cellular baseband processor 924, the application processor 906, or both the cellular baseband processor 924 and the application processor 906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 904 may include a variety of components configured for various functions. In one configuration, the apparatus 904, and in particular the cellular baseband processor 924 and/or the application processor 906, includes means for obtaining one or more measurements of at least one cell of a network based on a first connection with the network. The apparatus 904, and in particular the cellular baseband processor 924 and/or the application processor 906, includes means for reusing at least a first measurement of the one or more measurements for a second connection with the network. The first connection with the network and the second connection with the network may be associated with different subscriptions or different RATs.

In one configuration, the apparatus 904, and in particular the cellular baseband processor 924 and/or the application processor 906, includes means for identifying a first signal quality associated with the at least one cell based at least in part on the one or more measurements. At least the first measurement of the one or more measurements may be reused for the second connection if the first signal quality is greater than a first threshold. In one configuration, the first signal quality may correspond to an SNR or an RSRP. In one configuration, the apparatus 904, and in particular the cellular baseband processor 924 and/or the application processor 906, includes means for identifying a first age associated with the one or more measurements. At least the first measurement of the one or more measurements may be reused for the second connection if the first age is less than a second threshold. In one configuration, to reuse at least the first measurement of the one or more measurements for the second connection with the network, the apparatus 904, and in particular the cellular baseband processor 924 and/or the application processor 906, includes means for skipping a cell detection operation associated with the second connection with the network. In one configuration, the first connection with the network may be associated with a first subscription. The second connection with the network may be associated with a second subscription. The at least one cell of the network may correspond to a neighbor cell for the first connection. The at least one cell of the network may correspond to a serving cell for the second connection. In one configuration, the second connection with the network may be associated with a cell reselection. In one configuration, the first connection with the network may be associated with a first RAT. The second connection with the network may be associated with a second RAT. The second connection with the network may be associated with an IRAT redirection. In one configuration, the apparatus 904, and in particular the cellular baseband processor 924 and/or the application processor 906, includes means for obtaining system information of the at least one cell of the network from at least one first SIB based on the first connection with the network. The apparatus 904, and in particular the cellular baseband processor 924 and/or the application processor 906, includes means for reusing at least in part the system information for the second connection with the network. In one configuration, the apparatus 904, and in particular the cellular baseband processor 924 and/or the application processor 906, includes means for identifying a second signal quality associated with the at least one cell based at least in part on the one or more measurements. The system information may be reused at least in part for the second connection if the second signal quality is greater than a third threshold. In one configuration, the apparatus 904, and in particular the cellular baseband processor 924 and/or the application processor 906, includes means for identifying a second age associated with the system information. The system information may be reused at least in part for the second connection if the second age is less than a fourth threshold. In one configuration, to reuse at least in part the system information for the second connection with the network, the apparatus 904, and in particular the cellular baseband processor 924 and/or the application processor 906, includes means for skipping receiving or decoding at least one second SIB associated with the second connection with the network. In one configuration, the first connection with the network may be associated with a first subscription. The second connection with the network may be associated with a second subscription. The at least one cell of the network may correspond to a serving cell for the first connection. The at least one cell of the network may correspond to a serving cell for the second connection. In one configuration, the second connection with the network may be associated with a cell reselection. In one configuration, the second connection with the network may be associated with a recovery from an OOS or an RLF.

The means may be the component 198 of the apparatus 904 configured to perform the functions recited by the means. As described supra, the apparatus 904 may include the TX processor 368, the RX processor 356, and the controller/processor 359. As such, in one configuration, the means may be the TX processor 368, the RX processor 356, and/or the controller/processor 359 configured to perform the functions recited by the means.

Referring back to FIGS. 4-9, a UE may obtain one or more measurements of at least one cell of a network based on a first connection with the network. The UE may reuse at least a first measurement of the one or more measurements for a second connection with the network. The first connection with the network and the second connection with the network may be associated with different subscriptions or different RATs. Further, the UE may obtain system information of the at least one cell of the network from at least one first SIB based on the first connection with the network. The UE may reuse at least in part the system information for the second connection with the network. Accordingly, with the cell detection (and possibly SIB reading) skipped, delays associated with cell detection (and possibly SIB reading) may be avoided or reduced in scenarios such as IRAT reselection (e.g., L2NR reselection), cell reselection (e.g., NR2NR reselection), NAS service request, subscription power-on, OOS recovery, or RLF recovery, etc. Therefore, interruption to data transmission may be reduced and minimized in these scenarios.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used in this disclosure outside of the claims, the phrase “based on” is inclusive of all interpretations and shall not be limited to any single interpretation unless specifically recited or indicated as such. For example, the phrase “based on A” (where “A” may be information, a condition, a factor, or the like) may be interpreted as: “based at least on A,” “based in part on A,” “based at least in part on A,” “based only on A,” or “based solely on A.” Accordingly, as disclosed herein, “based on A” may, in one aspect, refer to “based at least on A.” In another aspect, “based on A” may refer to “based in part on A.” In another aspect, “based on A” may refer to “based at least in part on A.” In another aspect, “based on A” may refer to “based only on A.” In another aspect, “based on A” may refer to “based solely on A.” In another aspect, “based on A” may refer to any combination of interpretations in the alternative. As used in the claims, the phrase “based on A” shall be interpreted as “based at least on A” unless specifically recited differently.

The following aspects are illustrative only and may be combined with other aspects or teachings described herein, without limitation.

Aspect 1 is a method of wireless communication at a UE, including obtaining one or more measurements of at least one cell of a network based on a first connection with the network; and reusing at least a first measurement of the one or more measurements for a second connection with the network, the first connection with the network and the second connection with the network being associated with different subscriptions or different RATs.

Aspect 2 is the method of aspect 1, further including: identifying a first signal quality associated with the at least one cell based at least in part on the one or more measurements, where at least the first measurement of the one or more measurements is reused for the second connection if the first signal quality is greater than a first threshold.

Aspect 3 is the method of aspect 2, where the first signal quality corresponds to an SNR or an RSRP.

Aspect 4 is the method of any of aspects 1 to 3, further including: identifying a first age associated with the one or more measurements, where at least the first measurement of the one or more measurements is reused for the second connection if the first age is less than a second threshold.

Aspect 5 is the method of any of aspects 1 to 4, where to reuse at least the first measurement of the one or more measurements for the second connection with the network, and the method further includes: skipping a cell detection operation associated with the second connection with the network.

Aspect 6 is the method of any of aspects 1 to 5, where the first connection with the network is associated with a first subscription, the second connection with the network is associated with a second subscription, the at least one cell of the network corresponds to a neighbor cell for the first connection, and the at least one cell of the network corresponds to a serving cell for the second connection.

Aspect 7 is the method of aspect 6, where the second connection with the network is associated with a cell reselection.

Aspect 8 is the method of any of aspects 1 to 5, where the first connection with the network is associated with a first RAT, the second connection with the network is associated with a second RAT, and the second connection with the network is associated with an IRAT redirection.

Aspect 9 is the method of any of aspects 1 to 5, further including: obtaining system information of the at least one cell of the network from at least one first SIB based on the first connection with the network; and reusing at least in part the system information for the second connection with the network.

Aspect 10 is the method of aspect 9, further including: identifying a second signal quality associated with the at least one cell based at least in part on the one or more measurements, where the system information is reused at least in part for the second connection if the second signal quality is greater than a third threshold.

Aspect 11 is the method of any of aspects 9 and 10, further including: identifying a second age associated with the system information, where the system information is reused at least in part for the second connection if the second age is less than a fourth threshold.

Aspect 12 is the method of any of aspects 9 to 11, where to reuse at least in part the system information for the second connection with the network, and the method further includes: skipping receiving or decoding at least one second SIB associated with the second connection with the network.

Aspect 13 is the method of any of aspects 9 to 12, where the first connection with the network is associated with a first subscription, the second connection with the network is associated with a second subscription, the at least one cell of the network corresponds to a serving cell for the first connection, and the at least one cell of the network corresponds to a serving cell for the second connection.

Aspect 14 is the method of aspect 13, where the second connection with the network is associated with a cell reselection.

Aspect 15 is the method of aspect 13, where the second connection with the network is associated with a recovery from an OOS or an RLF.

What is claimed is:

1. An apparatus for wireless communication at a user equipment (UE), comprising:
a memory; and
at least one processor coupled to the memory and, based at least in part on information stored in the memory, the at least one processor is configured to:
obtain one or more measurements of at least one cell of a network based on a first connection with the network; and
reuse at least a first measurement of the one or more measurements for a second connection with the network, the first connection with the network and the second connection with the network being associated with different subscriptions or different radio access technologies (RATs).

2. The apparatus of claim 1, the at least one processor being further configured to:
identify a first signal quality associated with the at least one cell based at least in part on the one or more measurements, wherein at least the first measurement of the one or more measurements is reused for the second connection if the first signal quality is greater than a first threshold.

3. The apparatus of claim 2, wherein the first signal quality corresponds to a signal-to-noise ratio (SNR) or a reference signal received power (RSRP).

4. The apparatus of claim 1, the at least one processor being further configured to:
identify a first age associated with the one or more measurements, wherein at least the first measurement of the one or more measurements is reused for the second connection if the first age is less than a second threshold.

5. The apparatus of claim 1, wherein to reuse at least the first measurement of the one or more measurements for the second connection with the network, the at least one processor is further configured to:
skip a cell detection operation associated with the second connection with the network.

6. The apparatus of claim 1, wherein the first connection with the network is associated with a first subscription, the second connection with the network is associated with a second subscription, the at least one cell of the network corresponds to a neighbor cell for the first connection, and the at least one cell of the network corresponds to a serving cell for the second connection.

7. The apparatus of claim 6, wherein the second connection with the network is associated with a cell reselection.

8. The apparatus of claim 1, wherein the first connection with the network is associated with a first RAT, the second connection with the network is associated with a second RAT, and the second connection with the network is associated with an IRAT redirection.

9. The apparatus of claim 1, the at least one processor being further configured to:
obtain system information of the at least one cell of the network from at least one first system information block (SIB) based on the first connection with the network; and
reuse at least in part the system information for the second connection with the network.

10. The apparatus of claim 9, the at least one processor being further configured to:
identify a second signal quality associated with the at least one cell based at least in part on the one or more measurements, wherein the system information is reused at least in part for the second connection if the second signal quality is greater than a third threshold.

11. The apparatus of claim 9, the at least one processor being further configured to:
identify a second age associated with the system information, wherein the system information is reused at least in part for the second connection if the second age is less than a fourth threshold.

12. The apparatus of claim 9, wherein to reuse at least in part the system information for the second connection with the network, the at least one processor is further configured to:
skip receiving or decoding at least one second SIB associated with the second connection with the network.

13. The apparatus of claim 9, wherein the first connection with the network is associated with a first subscription, the second connection with the network is associated with a second subscription, the at least one cell of the network corresponds to a serving cell for the first connection, and the at least one cell of the network corresponds to a serving cell for the second connection.

14. The apparatus of claim 13, wherein the second connection with the network is associated with a cell reselection.

15. The apparatus of claim 13, wherein the second connection with the network is associated with a recovery from an out of service (OOS) or a radio link failure (RLF).

16. The apparatus of claim 1, further comprising a transceiver coupled to the at least one processor.

17. A method of wireless communication at a user equipment (UE), comprising:
obtaining one or more measurements of at least one cell of a network based on a first connection with the network; and
reusing at least a first measurement of the one or more measurements for a second connection with the network, the first connection with the network and the second connection with the network being associated with different subscriptions or different radio access technologies (RATs).

18. The method of claim 17, further comprising:
identifying a first signal quality associated with the at least one cell based at least in part on the one or more measurements, wherein at least the first measurement of the one or more measurements is reused for the second connection if the first signal quality is greater than a first threshold.

19. The method of claim 18, wherein the first signal quality corresponds to a signal-to-noise ratio (SNR) or a reference signal received power (RSRP).

20. The method of claim 17, further comprising:
identifying a first age associated with the one or more measurements, wherein at least the first measurement of the one or more measurements is reused for the second connection if the first age is less than a second threshold.

21. The method of claim 17, wherein to reuse at least the first measurement of the one or more measurements for the second connection with the network, and the method further comprises:
skipping a cell detection operation associated with the second connection with the network.

22. The method of claim 17, wherein the first connection with the network is associated with a first subscription, the second connection with the network is associated with a second subscription, the at least one cell of the network corresponds to a neighbor cell for the first connection, and the at least one cell of the network corresponds to a serving cell for the second connection.

23. The method of claim 22, wherein the second connection with the network is associated with a cell reselection.

24. The method of claim 17, wherein the first connection with the network is associated with a first RAT, the second connection with the network is associated with a second RAT, and the second connection with the network is associated with an IRAT redirection.

25. The method of claim 17, further comprising:
obtaining system information of the at least one cell of the network from at least one first system information block (SIB) based on the first connection with the network; and
reusing at least in part the system information for the second connection with the network.

26. The method of claim 25, further comprising:
identifying a second signal quality associated with the at least one cell based at least in part on the one or more measurements, wherein the system information is reused at least in part for the second connection if the second signal quality is greater than a third threshold.

27. The method of claim 25, further comprising:
identifying a second age associated with the system information, wherein the system information is reused at least in part for the second connection if the second age is less than a fourth threshold.

28. The method of claim 25, wherein to reuse at least in part the system information for the second connection with the network, and the method further comprises:
skipping receiving or decoding at least one second SIB associated with the second connection with the network.

29. An apparatus for wireless communication at a user equipment (UE), comprising:
means for obtaining one or more measurements of at least one cell of a network based on a first connection with the network; and
means for reusing at least a first measurement of the one or more measurements for a second connection with the network, the first connection with the network and the second connection with the network being associated with different subscriptions or different radio access technologies (RATs).

30. A computer-readable medium storing computer executable code at a user equipment, the code when executed by a processor causes the processor to:
obtain one or more measurements of at least one cell of a network based on a first connection with the network; and
reuse at least a first measurement of the one or more measurements for a second connection with the network, the first connection with the network and the second connection with the network being associated with different subscriptions or different radio access technologies (RATs).
